(19) United States
(12) Patent Application Publication
(10) Pub. No.: US 2012/0296660 A1
(43) Pub. Date: Nov. 22, 2012

(54) Method of Limiting Health Care Costs

(76) Inventors: Marina Myers, Grants Pass, OR (US); Stewart Myers, Philomath, OR (US)

(21) Appl. No.: 13/113,024

(22) Filed: May 20, 2011

(51) Int. Cl. G06Q 50/00; G06Q 10/00

(52) U.S. Cl. 705/2

(57) ABSTRACT

A method for limiting health care costs is provided. Patient data may be gathered to form a medical metric. The metric may be used to limit a patient's health care so that health care costs do not exceed an allowable threshold. The health care metric may contain limitations based on costs, availability of health care resources, or patient history. The method may also be used to limit anticipated health care costs by first predicting a patient's health care requirements, then controlling the amount or level of the health care used to meet those requirements.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to limiting health care costs and, more specifically, to applying a medical metric to medical treatment contemplated for patients and limiting that treatment if it exceeds allowable thresholds.

2. Description of the Related Art

The demand for quality health care is skyrocketing. One of the most significant contributors to this increase is the aging population. Both the number and proportion of older people are dramatically rising. In 2000, 35 million Americans were age 65 and older, representing 12.4 percent of the total population. This older population is expected to reach 54 million in 2020 and more than double in size by 2050, to account for 20 percent of our population.

Quality health care is a very limited resource. Health care providers are under increased pressure to reduce costs while maintaining or improving current levels of care. Insurance providers are constantly looking for ways to lower expenditures so they can become more flexible and responsive while still maintaining adequate safeguards. Consumers face rising costs in the form of increased premiums while managed care programs limit available health care opportunities. The health care industry faces many challenges in remaining financially viable while still providing the highest quality health care to consumers. It is becoming painfully obvious that to meet these challenges, the amount, quality, and extent of care must be closely managed to maximize the effectiveness of treatment.

Patients are losing the ability to pay. In 2008, expenditures for health care exceeded $2.3 trillion. This was more than three times the amount spent in 1990, $714 billion, and over eight times more than the amount spent in 1980, $253 billion. Health care spending in 2008 accounted for 16.2% of the nation's gross domestic product and amounted to an average of $7,681 per US resident. As health care costs continue to rise, some consumers can no longer afford to pay their deductibles, premiums, or maintain their managed care programs. There is a need for a method to combat the rising health care costs by ensuring that valuable medical resources are not wasted and are used with the maximum possible benefit.

Failure to pay lowers the quality of health care. As the costs of insurance and managed care programs increase, people are opting out in the hopes that they and their families will remain healthy. In 2004 there were 45 million uninsured in the US. The country's emergency rooms are quickly becoming overwhelmed as the uninsured turn to them for even routine care. Even those that are insured can easily become financially drained in the face of prolonged or severe illnesses. Quite often, disproportionate medical bills are unpaid or the patient turns to bankruptcy relief to avoid the debts. When this happens, the health care providers are left with no recovery. The cumulative and increasing effect of not receiving payment is causing some providers to scale back the level and quality of service they offer. There is a strong need for a method to help providers manage their risks by selecting treatments commensurate with a patient's financial capabilities.

### BRIEF SUMMARY OF THE INVENTION

A method for reducing health care costs through the use of a health care valuation metric is disclosed. Information regarding a patient's history, medical condition, costs involved, and other factors may be used to develop the metric. This metric serves as a regulator for determining the amount and level of health care to provide to a patient. By controlling, and possibly limiting, the health care received by one patient, it may be possible to efficiently extend health care to other patients. The metric may be distributed to health care providers, insurance companies, the patient, or anyone else with a pecuniary interest in the patient's health care. Those interested parties may use the metric to develop treatment plans.

In one exemplary embodiment of the present invention, the metric is constructed from a plurality of valuation considerations. These considerations may have equal or unequal importance in formulating the metric. A customized database could be constructed containing the valuation considerations and their weightings, any combination of which could be used to generate the metric. The metric may also be used to evaluate the desirability of providing health care to the patient in view of the needs of other patients and the availability of health care resources.

In another exemplary embodiment of the present invention, the method could be used to limit the cost of predicted health care requirements. Based on the predicted costs, a decision could be made as to the amount or level of health care to offer the patient. The prediction model, through incorporation of the health care metric, could make use of factors unique to a patient such as age, weight, gender, and family history. It has been shown that these and other health-related factors can predict the likelihood of contracting certain types of diseases. By predicting the likelihood of certain types of illnesses, or even the probability of recurrence for existing illnesses, health care providers could estimate the total cost and resources required to properly treat a patient. Based on that estimate, health care providers could equitably distribute limited resources to that patient, or across a plurality of patients. Furthermore, parties responsible for paying for a patient's care would be able to make an informed decision as to the type and level of care to be received.

In yet another exemplary embodiment of the present invention, the metric could be used as part of a method for determining whether non-traditional, experimental, or limited-result types of treatments or procedures should be provided to a patient. Unfortunately, traditional medical procedures sometimes fail to produce the desired result. Diseases can be more aggressive than initially thought, or patients may simply fail to respond due to physiological complications. When an initial course of treatment does not succeed, it is common for providers to attempt alternative treatments in the hope of restoring a patient's health. If those alternatives fail, subsequent alternatives may be attempted. Because treatment strategies are generally predicated on choosing the course with the highest probability of success first, each successive treatment strategy has a lower likelihood of succeeding. The invention could be used in a decision model for determining a maximum number of attempts for treating a condition.

In yet another exemplary embodiment of the present invention, the metric could be used as part of a method for determining which tests or examinations should be provided to a patient. Medical conditions do not always present themselves in a clear, easily identifiable manner. To develop an accurate prognosis, providers must have the necessary information for identifying a patient's condition. As with medical treatments, the test or examination with the highest likelihood success is usually ordered first. Should that test or examination fail to provide the required information, alternatives are attempted in an effort to diagnose the patient's condition. Each successive test or examination has a lower likelihood of providing the required information. Problems can arise when expensive tests are ordered that do not have high likelihood of success, or when there are limited testing resources for large patient populations. This latter situation could be potentially deadly in situations where the same type of testing method, magnetic resonance imaging for example, is used in cases ranging from long-term and benign to rapid-onset and aggressively malignant. Those patients with rapidly developing conditions could be seriously threatened if there is a long backlog for testing services. The metric could be used in a decision model for determining who should have access to particular testing services.

In yet another exemplary embodiment of the present invention, the invention could be used as part of a method for determining the availability of elective procedures. Elective procedures are those that are not medically necessary, but are seen by some as enhancing their quality of life. Some elective procedures may be covered by insurance or medical compensation plans whereas others are the responsibility of the patient. For the more popular procedures, there may not be sufficient medical resources to efficiently meet the needs of those seeking the procedure. Some providers of elective procedures, surgeons skilled in a particular area for example, may be in high-demand thereby forcing patients to wait on a long list before receiving treatment. The invention could be used in a decision model for determining access to limited elective procedure resources, or to providers that are in high-demand.

### BRIEF DESCRIPTION OF THE SEVERAL VIEWS OF THE DRAWING(S)

A further understanding of the present invention can be obtained by reference to a preferred embodiment set forth in the illustrations of the accompanying drawings. Although the illustrated embodiment is merely exemplary of methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a block diagram of an exemplary method for generating a health care metric that may be used in reducing health care costs as according to one embodiment of the present invention;

FIG. 2 is a flowchart diagram of an exemplary health care reduction method utilizing a medical metric as according to one embodiment of the present invention;

FIG. 3 is a block diagram of an exemplary method for limiting the cost of predicted health care requirements as according to one embodiment of the present invention;

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

The term “patient” may be used interchangeably herein to refer to a single person, or to any plurality of persons for whom health care is contemplated. Although the following description and claims may refer to a patient in the singular, it is understood that “patient” may refer to patients in the multiple.

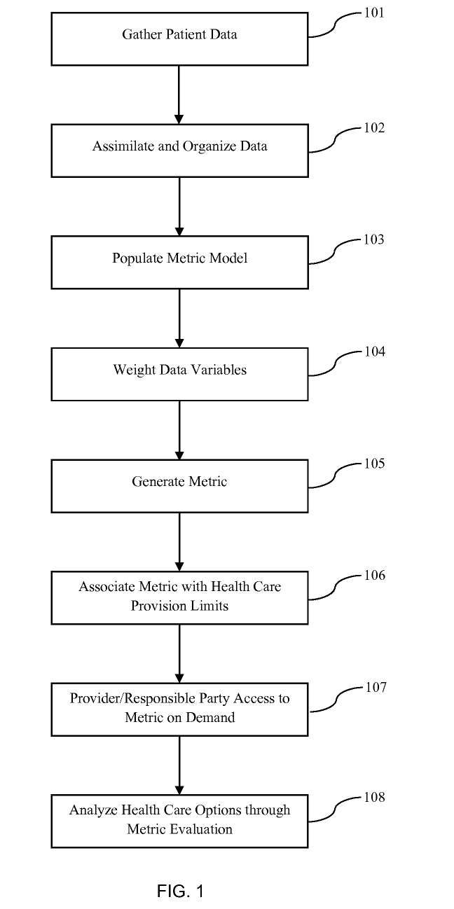

Referring now to FIG. 1, there is shown an exemplary method for generating a health care metric that may be used in reducing health care costs as according to one embodiment of the present invention. Patient data is gathered (101), the data consisting of factors attributable to a patient. These factors may include, but are not limited to: age, gender, ethnicity, religious preference, sexual orientation, nationality, place of birth, marital status, physical health information, mental health information, blood pressure, weight, cholesterol values, body mass index, pregnancy status, number of children, alcohol information, tobacco information, illegal drug information, prescription medication information, vitamin or supplement information, over-the-counter medicine information, allergy information, duration of current illness, nature of current illness, medical history, mental illness history, costs of health care received, costs of health care to be provided, previous and current residence information, exercise information, financial history, net worth, payment history, outstanding debts, current patient balance, education level, work history, credit information, charitable donation information, credit score, credit history, debt vs. spending ratio, asset ownership, physical injury or accident information, family history, criminal history, firearm and non-firearm weapon ownership, profession, handicaps, diet, travel information, driving record, evidence of child or elder abuse, VIP status, honorariums, awards, certifications, commendations, promotions, achievements, prizes, factors or considerations that may indicate social worth, and any other factor that may indicate the desirability of providing health care to the patient. These aforementioned factors may be used individually or in any combination thereof as part of the health care metric generation process.

After gathering the patient data (101) required for generating the health care metric (105), the data is assimilated and organized (102) into the necessary form. Often when data is gathered it is taken from non-standardized formats. It must first be translated into a form suitable for the particular application used to generate the metric. This step can include eliminating unnecessary data; converting information into the appropriate format, pounds to kilograms by way of example; checking the accuracy, consistency, and completeness of the gathered data; and otherwise preparing data as may be required by any computer or manual process utilized to generate the metric.

Once data has been assimilated and organized (102), the model used to generate the medical metric is populated (103) with the patient data. This model can be a mathematical formula that takes as input the gathered patient data (101) and generates as output the medical metric (105). As an optional step in generating the medical metric (105) the data variables could be given different weightings (104) to reflect the significance of the variables. This optional step allows variables that have different importance to impact the generated medical metric (105) in accordance with their importance. Once the medical metric has been generated (105), those implementing the invention may associate the metric with health care provision limitations (106). By way of example, these limitations can include spending caps, medical procedure prohibitions, examination or screening limits, or any other sort of control that may be desirable to place on a patient's health care. The purpose of optionally associating the metric with health care provision limitations (106) may be to control health care related spending or to ensure that health care resources are allocated in a fair and equitable manner.

The medical metric may be provided to health care providers and responsible parties on an on-demand basis (107). Responsible parties may include any individual, group, organization, company, or anyone else responsible for payment of health care, or for making decisions regarding the health care of a patient. Typically, insurance companies and guarantors that are responsible for paying for all or part of a patient's health care may be considered a responsible party. In some situations, those with power of attorney or those acting in accordance with an Advance Directive may also be considered a responsible party.

Once the medical metric has been obtained by a health care provider or responsible party, the health care options proposed for a patient may be evaluated in view of the limitations of the metric (108). Health care options may generally be considered any treatment, procedure, test, examination, or other activity relating to medical treatment. Should a proposed health care option fall outside the bounds of what is permitted or recommended by the metric, that option may be rejected and other options considered in its place. Essentially, the health care metric establishes an allowable threshold, whether monetary or otherwise, that is used to allow or disallow providing health care options. Should a medical option be too expensive, by way of example, from what is permitted by the medical metric, a less expensive option may be considered in its place. Medical metric regulation of health care options will permit providers and responsible parties to limit expenditures and conserve health care resources.

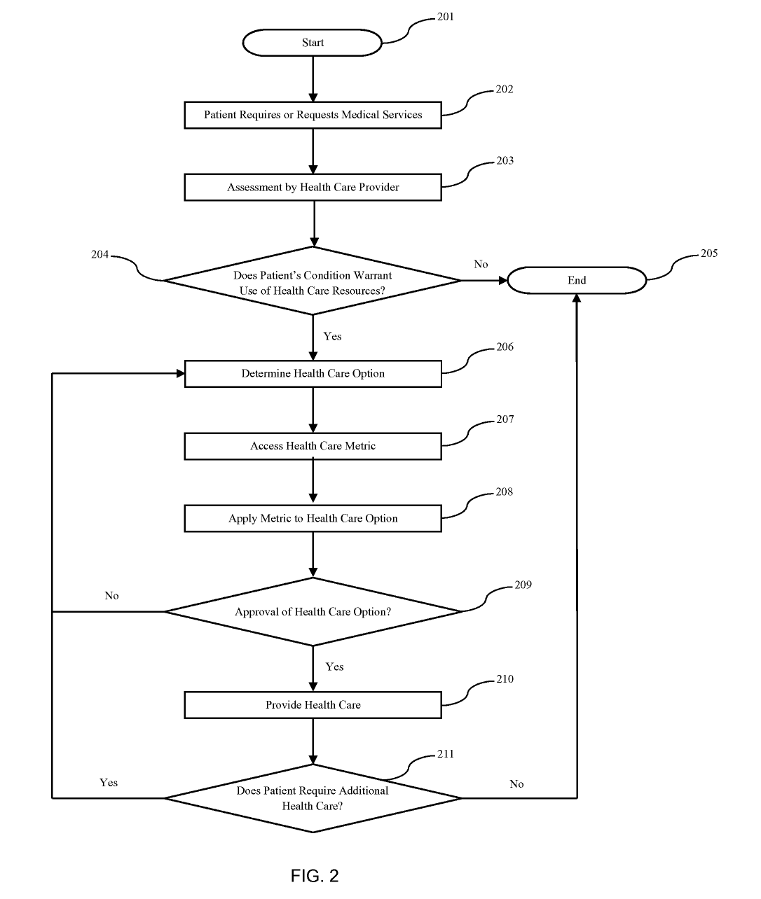

Referring now to FIG. 2, there is shown an exemplary health care reduction method utilizing a medical metric as according to one embodiment of the present invention. When a patient requires or requests medical services (202) a health care provider assesses the patient's condition (203). A health care provider may be considered any person or plurality of persons that provides health services to a patient. If the health care provider decides that the patient's condition warrants the use of health care resources (204), the provider then determines which health care option is best for treating the patient (206). The provider, or responsible party, may then access the patient's health care metric (207) and apply the health care metric to the chosen health care option (208) and evaluate whether the metric allows for providing the chosen health care option. If the health care metric allows for providing the chosen health care option (209), the patient receives treatment. If the health care metric does not allow for the health care option (209) a different health care option may be determined (206) by the health care provider and the method's steps are repeated (207)-(209). After receiving treatment, if the patient's condition has not improved or if the patient requires additional health care (211), then the provider may determine another health care option (206) is appropriate for the patient and the method's steps are repeated (207)-(211).

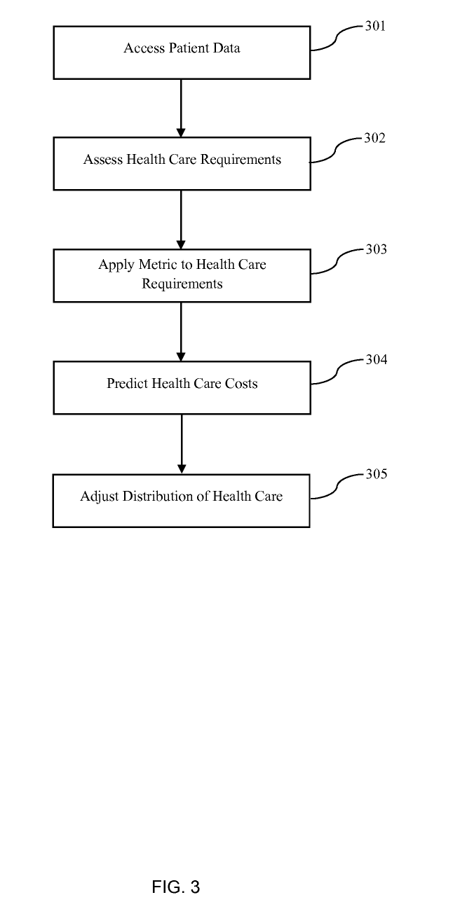

Referring now to FIG. 3, there is shown an exemplary method for limiting the cost of predicted health care requirements as according to one embodiment of the present invention. Because the medical metric used in a preferred embodiment of the present invention may provide limits on health care spending for a patient, it could be possible to predict total health care spending for a patient over a given interval of time. To predict health care spending, patient data may be accessed (301) to assess the possible future health care requirements (302) that the patient may have. These health care requirements may be current illnesses, desired elective procedures, or any condition that warrant administering health care. Once the health care requirements have been assessed (302), the medical metric is applied to those requirements (303) to determine the expense of the health care to be provided to a patient. This step may generally involve setting an upper spending limit cap on the health care that a patient may require. Once the metric is applied to the health care requirements and an upper spending limit on patient health care is established, the future health care costs of the patient may be accurately predicted (304).

Based on the predicted health care costs (304), health care resources may be redistributed (305) to better accommodate the needs of all patients. This step may generally involve substituting less expensive or less time-consuming health care options in place of more expensive or more time-consuming options. By way of example, X-Ray imaging may be substituted in place of more expensive and time consuming magnetic resonance imaging. This step may also involve denying particular types of health care to a patient because the cost exceeds the spending limits established by the metric.

At least some of the above described example methods and/or apparatus may be implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for limiting health care costs comprising the steps of:
gathering patient data;
processing the patient data so that it is suitable for use in generating a health care metric;
converting the patient data into variables for use in generating the health care metric whereby converting the patient data includes weighting or not weighting data elements to reflect data elements of differing importance;
generating the health care metric;
applying the health care metric to health care services in contemplation for a patient; and
limiting the health care services if the health care metric indicates any characteristic of the health care services exceed an allowable threshold.

2. The method of claim 1, further comprising limiting the health care services if the health care metric indicates the cost of the health care services exceeds an allowable cost threshold.

3. The method of claim 1, further comprising applying the health care metric to alternative health care services in contemplation for a patient should the initial health care services exceed the health care metric's allowable threshold.

4. The method of claim 1, further comprising providing the health care metric to health care providers or responsible parties.

5. The method of claim 1, further comprising choosing health care options for the patient that satisfy the requirements of the health care metric.

6. The method of claim 1, further comprising substituting less expensive health care options for more expensive health care options to lower the cost of the health care.

7. A method for limiting the cost of health care provided to a patient comprising the steps of:
Assessing the patient's health care needs by a health care provider;
deciding whether the patient's health care needs warrant use of health care resources;
selecting a health care option that meets the patient's health care needs;
evaluating whether to provide the selected health care option to the patient by applying a health care metric to the selected health care option; and
providing the selected health care option to the patient if the health care metric allows for provision of the selected health care option.

8. The method of claim 7, further comprising not providing the selected health care option if the health care metric does not allow for provision of the selected health care option.

9. The method of claim 7, further comprising selecting a different health care option if the health care metric does not allow for providing a first health care option.

10. The method of claim 7, further comprising determining whether a patient requires additional health care after providing the selected health care option.

11. The method of claim 7, further comprising substituting a less expensive health care option for a more expensive health care option to lower the health care costs.

12. The method of claim 11, further comprising selecting a subsequent health care option, evaluating whether to provide the subsequent health care option to the patient by applying the health care metric to the subsequent health care option, and providing the subsequent health care option to the patient if the health care metric allows for providing the subsequent health care option.

13. The method of claim 12, further comprising not providing the subsequent health care option if the health care metric does not allow for providing the subsequent health care option.

14. A method for limiting the cost of predicted health care comprising:
accessing patient data;
assessing the future health care requirements of the patient from indications found in the patient data;
applying limitations of a health care metric to the future health care requirements; and
estimating the future health care costs as limited by the health care metric.

15. The method of claim 14, further comprising adjusting the distribution of health care resources across a plurality of patients based on the estimated future health care costs.

16. The method of claim 14, further comprising limiting the current health care provided to a patient based on the estimated future health care costs.

17. The method of claim 14, further comprising substituting less expensive health care options for more expensive health care options to lower estimated future health care costs.
